(19) United States
(12) Patent Application Publication
(10) Pub. No.: US 2018/0205117 A1
(43) Pub. Date: Jul. 19, 2018

(54) SOLID POLYMER ELECTROLYTE

(71) Applicant: DSM IP ASSETS B.V., Heerlen (NL)

(72) Inventors: Carel Frederik Constantijn FITIÉ, Echt (NL); Robert Hendrik Catharina JANSSEN, Echt (NL); Alexander Antonius Marie STROEKS, Echt (NL)

(21) Appl. No.: 15/741,573

(22) PCT Filed: Jul. 8, 2016
(86) PCT No.: PCT/EP2016/066282

§ 371 Date: Jan. 3, 2018

(30) Foreign Application Priority Data
Jul. 9, 2015 (EP) 15176131.9

(51) Int. Cl. H01M 10/0565; H01M 10/0525; H01M 10/054; H01M 2/16; H01M 4/62

(52) U.S. Cl. CPC H01M 10/0565; H01M 10/0525; H01M 10/054; H01M 2300/0082; H01M 2/166; H01M 2/1646; H01M 4/622; H01M 2/168

(57) ABSTRACT

Solid polymer electrolyte containing A: a thermoplastic elastomer containing polyester, polyamide or diamide hard blocks and ionically conductive soft blocks and B: a metal salt and less than 15 wt. % of a plasticizer. The electrolyte may be used as a spacer in a battery, a binder in an electrode and an adhesive film between a spacer and at least one electrode of a battery.

The present invention relates to solid polymer electrolyte materials. Such materials are ionically conductive, mechanically robust, and may be manufactured by conventional polymer processing methods. The solid polymer electrolyte is suitable for use in rechargeable batteries. The demand for rechargeable batteries has grown considerably as the global demand for technological products such as cellular phones, laptop computers and other consumer electronic products has escalated. In addition, interest in rechargeable batteries has been fueled by current efforts to develop green technologies such as electrical-grid load leveling devices and electrically-powered vehicles, which are creating an immense potential market for rechargeable batteries with high energy densities.

Li-ion batteries represent one of the most popular types of rechargeable batteries for portable electronics. Li-ion batteries offer high energy and power densities, slow loss of charge when not in use, and they do not suffer from memory effects. Because of many of their benefits, including their high energy density, Li-ion batteries have also been used increasingly in defense, aerospace, back-up storage, and transportation applications.

The electrolyte is an important part of a typical Li-ion rechargeable battery. Traditional Li-ion rechargeable batteries have employed liquid electrolytes. An exemplary liquid electrolyte in Li-ion batteries consists of lithium-salt electrolytes, such as LiPF₆, LiBF₄, or LiClO₄, and organic solvents, such as an alkyl carbonate. During discharging, the electrolyte may serve as a simple medium for ion flow between the electrodes, as a negative electrode material is oxidized, producing electrons, and a positive electrode material is reduced, consuming electrons. These electrons constitute the current flow in an external circuit.

While liquid electrolytes dominate current Li-based technologies, solid electrolytes may constitute the next wave of advances for Li-based batteries. The lithium solid polymer electrolyte rechargeable battery is an especially attractive technology for Li-ion batteries because, among other benefits, the solid polymer electrolyte exhibits high thermal stability, low rates of self-discharge, stable operation over a wide range of environmental conditions, enhanced safety, flexibility in battery configuration, minimal environmental impacts, and low materials and processing costs. Moreover, solid polymer electrolytes may enable the use of lithium metal anodes, which offer higher energy densities than traditional lithium ion anodes.

Lithium batteries with solid electrolytes function as follows. During charging, a voltage applied between the electrodes of a battery causes lithium ions and electrons to be withdrawn from lithium hosts at the battery's positive electrode. Lithium ions flowing from the positive electrode to the battery's negative electrode through a polymer electrolyte are reduced at the negative electrode. During discharge, the opposite reaction occurs. Lithium ions and electrons are allowed to re-enter lithium hosts at the positive electrode as lithium is oxidized at the negative electrode. This energetically favorable, spontaneous process converts chemically stored energy into electrical power that an external device can use.

Polymeric electrolytes have been the subject of academic and commercial battery research for several years. Polymer electrolytes have been of exceptional interest partly due to their low reactivity with lithium and potential to act as a barrier to the formation of metallic lithium filaments (or dendrites) upon cycling.

According to one example, polymer electrolytes are formed by incorporating lithium salts into appropriate polymers to allow for the creation of electronically insulating media that are however ionically conductive. Such a polymer offers the potential to act both as a solid state electrolyte and separator in primary or secondary batteries. Such a polymer can form solid state batteries that exhibit high thermal stability, low rates of self-discharge, stable operation over a wide range of environmental conditions, enhanced safety, and higher energy densities as compared with conventional liquid-electrolyte batteries.

Despite their many advantages, the adoption of polymer electrolytes has been curbed by the inability to develop an electrolyte that exhibits both high ionic conductivity and good mechanical properties. This difficulty arises because high ionic conductivity, according to standard mechanisms, calls for high polymer chain mobility. But high polymer chain mobility, according to standard mechanisms, tends to produce mechanically soft polymers.

As an example, a prototypical polymer electrolyte is one comprising polyethylene oxide (PEO)/salt mixtures. PEO generally offers good mechanical properties at room temperature. However, PEO is also largely crystalline at room temperature. The crystalline structure generally restricts chain mobility, reducing conductivity. Operating PEO electrolytes at high temperature (i.e., above the polymer's melting point) solves the conductivity problem by increasing chain mobility and hence improving ionic conductivity. However, the increased conductivity comes at a cost in terms of deterioration of the material's mechanical properties. At higher temperatures, the polymer no longer behaves as a solid.

In general, attempts to stiffen PEO, such as through addition of hard colloidal particles, increasing molecular weight, or cross-linking, have been found to also cause reduced ionic conductivity.

In U.S. Pat. No. 8,268,197 a polymeric electrolyte material has been proposed with high ionic conductivity and mechanical stability where the material is amenable to standard high-throughput polymer processing methods. The polymeric electrolyte comprises linear two-block or tri-block polymers that form a two phase lamellar structure, of adjacent conductive and non-conductive lamellae. One of the phases is the conductive phase, the other on is a structural phase. An example of polymer that may be used in the electrolyte material is a polystyrene-polyethylene oxide-polystyrene copolymer.

In WO2012/083253 a similar electrolyte material has been described, comprising a polystyrene-poly(glycidyl ether) copolymer.

A problem with the polymeric electrolyte known from U.S. Pat. No. 8,268,197 is that the production of the two-phase structure requires a stringent control of the processing conditions in the production process of the polymeric electrolyte. Fluctuation in the structure may occur between batteries resulting in undesired fluctuations in quality, such as conductivity, mechanical properties and resistance against the formation of dendrites at the surface of the Li-electrode.

From US 2014/0023931 an electrolyte material is known which is a physically cross-linked gel. As a polymer block copolymers comprising polyamide or polyester hard blocks and ionically conductive soft blocks. The gel comprises a high amount of plasticizer, since the gel is formed by saturating the block copolymer with the plasticizer in a bath. This results in a very high content of plasticizer of at least 100 wt %. A problem with this kind of electrolyte materials is that the production of the batteries is very complicated.

Aim of the invention is to provide a solid polymer electrolyte, that provides easy processing.

Surprisingly this object is obtained when the solid polymer electrolyte contains a thermoplastic elastomer containing polyester, polyamide or diamide hard blocks and ionically conductive soft blocks and a metal salt and which solid polymer electrolyte has a total plasticizer content of less than 15 wt. %.

Surprisingly, it is now possible to manufacture a complete electrode-cathode system by melting the electrolyte material in an extruder and laminating the electrolyte material between the electrodes.

A further advantage is that the electrode material according to invention is less sensitive to the formation of dendritic structures on the electrode, causing failure of the battery.

Furthermore if used as a spacer in a battery, the battery is mechanically robust.

A further advantage is that the electrolyte material does not contain too much low molecular weight compounds that may evaporate during manufacture and use.

Yet a further advantage is that the electrochemical stability, for example as measured with cyclic voltammetry (CV), is improved.

A thermoplastic elastomer is a rubbery material with the processing characteristics of a conventional thermoplastic and below its melting temperature the performance properties of a conventional thermoset rubber. Thermoplastic elastomers are described in Handbook of Thermoplastic Elastomers, second edition, Van Nostrand Reinhold, New York (ISBN 0-442-29184-1).

The ionically conductive soft block is comprised of one or more highly electronegative oxygen-containing species, such as alkyl ethers, in which small monovalent and divalent cations are known to be solubilized.

The ionically conductive soft blocks may include segments of polyethylene oxide (PEO), polypropylene oxide (PPO) and polyglycidyl ether. Preferably the ionically conductive blocks contains segments of polyethylene oxide PEO.

The ionically conductive soft block may contain PEO segments having a number average molecular weight of between 300 and 20.000 kg/kmol.

Preferably the number average molecular weight is at least 400 kg/kmol, more preferably at least 500 kg/kmol, even more preferably at least 600 kg/kmol. Preferably the number average molecular weight is smaller than 20000 kg/kmol, more preferably smaller than 10000 kg/kmol, most preferably smaller than 3.000 kg/kmol. The number average molecular weight is measured by a hydroxyl end group titration according to DIN EN 13926 after which the number average molar mass is calculated from the outcome of this analysis. It is possible that the polyethylene oxide segments originate from a poly(ethylene oxide)-terminated poly(propylene oxide)diol. It is however preferred that the electrically conductive soft blocks originate from a polyethylene oxide diol. Most preferably the soft blocks of the thermoplastic elastomer consist for at least 80 wt. % of the polyethylene oxide segments, more preferably for at least 90 wt. %, even more preferably for at least 98 wt. %, most preferably for 100 wt. %.

The polyethylene oxide segments may comprise small amounts of randomly copolymerized co-monomers to suppress the crystallization of the segment. Examples of suitable co-monomers include propylene oxide, glycidyl ethers, etc. It is also possible that the ionically conductive soft block comprises a chain extender, preferably a di acid. The advantage of using a chain extender is that long ionically conductive soft blocks are obtained while chain regularity and, thus, crystallization are suppressed to allow higher ionic conductivity.

The concentration of the ionically conductive soft block in the thermoplastic elastomer is preferably higher than 50 wt %, more preferably higher than 60 wt %, still more preferably higher than 65 wt %, most preferably higher than 70 wt %.

The polyester hard segments suitably contains hard segments that are built up from repeating units derived from at least one alkylene diol and at least one aromatic dicarboxylic acid or an ester thereof. A block may comprise one or more segments of the same chemical composition. A segment comprises several repeating units. The alkylene diol may be a linear or a cycloaliphatic alkylene diol. The linear or cycloaliphatic alkylene diol contains generally 2-6 C-atoms, preferably 2-4 C-atoms. Examples thereof include ethylene glycol, propylene diol and butylene diol. Preferably ethylene diol or butylene diol are used, more preferably 1,4-butylene diol. Examples of suitable aromatic dicarboxylic acids include terephthalic acid, 2,6-naphthalenedicarboxylic acid, 4,4′-biphenyldicarboxylic acid or combinations of these. The advantage thereof is that the resulting polyester is generally semi-crystalline with a melting point of for example above 120, preferably above 150, and more preferably of above 190° C. The hard segments may optionally further contain a minor amount of units derived from other dicarboxylic acids, for example isophthalic acid, which generally lowers the melting point of the polyester. The amount of other dicarboxylic acids is preferably limited to not more than 10 mol %, more preferably not more than 5 mol %, so as to ensure that, among other things, the crystallization behaviour of the copolyetherester is not adversely affected. The hard segment is preferably built up from ethylene terephthalate, propylene terephthalate, and in particular from butylene terephthalate as repeating units. Advantages of these readily available units include favourable crystallisation behaviour and a high melting point, resulting in copolyetheresters with good processing properties, excellent thermal and chemical resistance and good puncture resistance.

Thermoplastic elastomers comprising polyamide hard blocks and polyethylene oxide soft blocks are available, for example, under the trade name PEBAX, from Arkema, France.

In a preferred embodiment the thermoplastic elastomer contains diamide hard segments. In this way a polymer electrolyte is obtained that shows good mechanical properties and a further increased resistance against the formation of dendrites, even at high soft block content.

Preferably the diamide hard blocks have been obtained from derived a diamine according to Form I,

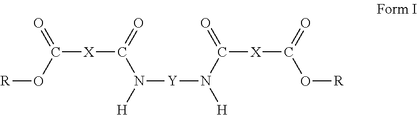

wherein X and Y are the same or different and are an aliphatic group comprising 2-12 carbon atoms or an aromatic group comprising 6-20 carbon atoms, R1 and R2 are the same or different and are an aliphatic group comprising 2-15 carbon atoms and wherein R equals R1 or R2 and are the same or different.

X and Y are the same or different and are an aliphatic group comprising 2-12 carbon atoms or an aromatic group comprising 6-20 carbon atoms. If X or Y is aliphatic, X or Y may be acyclic or cyclic aliphatic groups. Acyclic aliphatic groups may be linear or branched. Examples of linear aliphatic groups include 1,2-ethylene, 1,3-propylene, 1,4-butylene, 1,5-pentylene, 1,6-hexylene, 1,7-heptylene, 1,8-octylene, 1,9-nonylene, 1,10-decylene, 1,11-undecylene, and 1,12-dodecylene. Preferably 1,4-butylene is used as linear aliphatic group. Examples of branched aliphatic groups include 1,2-propane, 2,3-butane, 1,5-(2-methyl)pentylene, 2,5-hexane, 1,7-(3-methyl)heptylene, 1,9-(5-methyl)nonylene and 2,11-dodecylene. Examples of cyclic aliphatic groups include 1,2-cyclobutylene, 1,3-cyclobutylene, 1,3-cyclopentylene, 1,2-cyclohexylene, 1,3-cyclohexylene, 1,4-cyclohexylene, 2-methyl-1,3-cyclohexylene, 1,3-cycloheptylene, 1,4-cycloheptylene, 1,6-decahydronapthylene, 2,6-decahydronapthylene, 2,7-decahydronapthylene, 1,8-decahydronapthylene, 1,2-cyclohexyldimethylene, 1,3-cyclohexyldimethylene, 1,4-cyclohexyldimethylene and 4,4′-methylenedicyclohexylene. Preferably 1,4-cyclohexylene is used.

Examples of aromatic groups include p-phenylene, p-toluylene, p-xylylene, m-phenylene, m-toluylene, m-xylylene, 2,6-toluylene, 2,4-toluylene, 2,6-naphtylene, 2,7-naphtylene, 1,8-napthylene, 1,5-anthracylene, 1,8-anthracylene, 2,6-anthracylene, 2,7-anthracylene, 2,5-furylene, 3,4-furylene, 2,7-fluorenyl, 4,4′-(1,1′-biphenyl)ene, 3,3′-(1,1′-biphenyl)ene, 3,4′-(1,1′-biphenyl)ene, 2,4′-methylenediphenylene and 4,4′-methylenediphenylene. Preferably p-phenylene is used.

R1 and R2 are the same or different and are an acyclic or cyclic aliphatic group comprising 2-15 carbon atoms, preferably 2-12 carbon atoms.

If R1 or R2 are an acyclic group the group may be linear or branched. Examples of linear groups include. Ethyl, propyl, butyl, pentyl, hexyl, heptyl, octyl, nonyl, decyl, undecyl and dodecyl. Examples of branched groups include isopropyl, (2-methyl)propyl, tert-butyl, 2-butyl, (2-methyl)butyl, (2-ethyl)butyl, (2-ethyl)hexyl, 3-(6-methyl)heptyl, 4-(3-methyl)nonyl, isononyl, 1-heptyloctyl. Examples of cyclic groups include cyclopentyl, cyclohexyl, cyclohexanemethyl, cyclooctyl, Preferably 2-butyl, (2-methyl)butyl, (2-ethyl)butyl or (2-ethyl)hexyl are used

Preferably X, Y, R1 and R2 are selected to obtain a melting temperature of the diamide of at most 280° C., more preferably at most 260° C., most preferably at most 240° C. The melting temperature of the diamide increases in general with increasing weight of the groups X and Y if these groups are aromatic and decreases with increasing weight of the groups X, Y, R1, R2 if these groups are aliphatic.

Preferred diamines include di-aminobutane (DAB, indicated with “4” in the diamide) and p-phenylenediamine (indicated with “phi” in the diamide). Preferred diesters of dicarboxylic acid include diesters of terephthalic acid and (2-ethyl)hexanol (DOT, indicated with “T” in the diamide), the diester of 2,6-naphtalenedicarboxylic acid and (2-ethyl)hexanol (indicated with “N” in the diamide) and the diester of terephthalic acid and butanol (DBT). Preferred diamides therefore include T4T, TphiT, N4N and NphiN. The thermoplastic elastomer may be obtained by the reaction of the compound according to Form I and a polyethylene oxide diol, whereby the R-groups react with the hydroxyl groups of the polyethylene oxide diol.

The electrolyte according to the invention contains one of the above described thermoplastic elastomers and as electrolyte salt it may contain inorganic salts containing a cation of group Ia and IIa of the table of elements and as anion for example ClO₄⁻, SCN⁻, BF₄⁻, As F₆⁻, CF₃SO₃⁻, Br⁻, I⁻, PF₆⁻, (CF₃SO)₂N⁻, (CF₃SO)₃ C⁻, CF₃CO₂⁻, (FO₂S)₂N⁻ and the like. Preferred cations for the salts include Li for a lithium battery, and Na⁺ for a sodium battery and Al³⁺ for Al batteries. Lithium, sodium, aluminium battaries, are batteries that have an anode comprising lithium, sodium repectively aluminium.

The amount of salt in the electrolyte, expressed in mole metal of the salt:mole oxygen in the soft block of thermoplastic elastomer, may vary between 1:25 and 1:10, preferably between 1:20 and 1:15.

The total plasticizer content of the electrolyte material is at most 15 wt. %. A plasticizer is compound that lowers the hardness of polymer electrolyte material. The hardness is meant the shore hardness (ASTM D2240-15). Examples of plasticizers include organic carbonates, preferably small aliphatic and cycloaliphatic carbonates, for example ethyl methyl carbonate (EMC), diethyl carbonate (DEC), ethylene carbonate (EC), propylene carbonate (PC) or mixtures thereof as well as polyethylene oxide glycol. Preferably the total plasticizer content in the electrolyte material contains less than 10 wt. % of plasticizer, more preferably less than 5 wt. %, still more preferably 2 wt. %. Most preferably the electrolyte material does not contain a plasticizer. It is also possible that the electrolyte contains stabilizers for the electrode interface, heat stabilizers, processing aids and flame retardants.

The invention also relates to a spacer between adjacent electrodes of a battery, especially of a rechargeable battery, the spacer comprising the solid polymer electrolyte of the present invention.

The invention also relates to an electrode, especially an electrode for a rechargeable battery, comprising the solid polymer electrolyte of the present invention as a binder.

Very good results are obtained when the solid polymer electrolyte is used as a binder in the electrodes, especially in the cathode. This is because the binder according to the invention more conductive for ions, than the known binder, so increasing the output of the battery. In the electrode the binder acts to bind particles of active components, like for instance LiFePO₄ particles, preferably coated with carbon black, LiCoO₂ and (LiNiMn)CoO₂ particles. In case the particles are note coated with carbon black, preferably separate particles of a carbon-conductive agent, for instance carbon black or graphite, are incorporated into the cathode. The amount of binder used in the electrodes may be between 2.5 and 20 wt. % and is preferably between 5 and 10 wt. %.

Various processes for preparing such electrodes comprising a binder have been described in US2012/0202114. One way of producing the electrode comprises the steps of dry-solid mixing the particles of the active components and eventual carbon-conductive agent in a conventional impeller blade-type mixer. The binder polymer is dissolved in the solvent hexafluoroisopropanol (HFIP). The dry-mixed solids are fed into a ball mill along with the binder solution and then thoroughly mixed. The ball mixer consists of ceramic balls (glass, zirconia) with a diameter of a few millimeters to assist the mixing and obtain a slurry with a viscosity in the range 10,000-20,000 cps so that is can be easily handled in the next coating process. Coating operations on aluminum foil may use a slot-die, reverse roll coating or doctor blade coating. The coating process conditions are designed in such a way that a coating thickness in the range 50-300 micrometer is obtained. The cathode is dried to remove the solvent and the porous dried electrode is calendered to provide accurate control of the cathode thickness and to increase the density of the cathode mass.

The invention also relates to a battery, especially a rechargeable battery, comprising an adhesive film of the polymer electrolyte between the anode and/or the cathode at one hand and the spacer adjacent to the at least one anode and/or at least one cathode at the other hand.

Very good results are obtained with a battery comprising an adhesive film of the polymer electrolyte between at least one anode and/or at least one cathode at one hand and the spacer adjacent to the at least one anode and/or at least one cathode at the other hand. This is because the contact resistance between the electrodes and the spacer is decreased. Especially good results are obtained with a ceramic spacer, the film filling the pores in the spacer.

The invention is further explained in the examples, without being restricted thereto.

### Used Polymers:

TPE1: a thermoplastic copolyester elastomer, comprising 35 wt. % poly(ethyleneglycol) (PEG) soft blocks and 65 wt. % polybutylene terephthalate hard blocks. The number average molecular weight (Mn) of the PEG is 2000 g/mol.

TPE2: a thermoplastic copolyester elastomer, comprising 70 wt. % (PEG) soft blocks and 30 wt. % polybutylene terephthalate hard blocks. The number average molecular weight (Mn) of the PEG is 4000 g/mol.

TPE3: a thermoplastic elastomer containing diamide hard blocks. The TPE comprises 10 wt. % TphiT hard block derived from diamide of form I, where X and Y are both p-phenylene. The TPE further comprises 90 wt. % of an ionically conductive soft block of PEG with a number average molecular weight (Mn) of 2000 g/mol and a terephthalic acid chain extender.

PEG-DME, methyl end-capped poly(ethylene glycol), the number average molecular weight (Mn) is 2000 g/mol.

### EXAMPLE I

The polymer electrolyte film was produced in the following manner. TPE1 was dried for 24 hrs at 110 C in an oven system under dry nitrogen flush. 3 g of the dried polymer is dissolved in 20 ml of hexafluoroisopropanol (HFIP) in a stirred glass vessel. To this mixture, 0.335 g of the salt lithium bis-trifluoromethanesulfonyl-imide (LiTFSI) is added and dissolved upon stirring. For this case the molar ratio ethyleneoxide/Li-ion is 20. The mixture is cast on a teflon film under argon flow at room temperature and dried at 70 C for 10 hrs to obtain free standing, rather tough solid-like electrolyte films with a thickness of 200 respectively 500 microns and an area of approximately 5 cm².

The DC electrical conductivity of the films was measured by clamping the films between stainless steel plates and applying impedance spectroscopy by a frequency response analyzer in a frequency range of 1 Hz-300 kHz. The surface of the films was before clamping sputtered by a gold layer to improve contact with the electrodes. The electrical conductivity is measured at various temperatures, see table 1.

TABLE 1

| Temperature | −10° C. | 23° C. | 40° C. | 80° C. |
|---|---|---|---|---|
| Electrical | 10⁻⁸ | 2*10⁻⁶ | 2*10⁻⁵ | 10⁻⁴ |
| conductivity in S/cm | | | | |

### EXAMPLE II

Polymer electrolyte films were prepared of TPE2 according to the procedure of example 1 unless otherwise stated. 3 g of the dried polymer is dissolved in 20 ml of hexafluoroisopropanol (HFIP) in a stirred glass vessel. To this mixture, 0.669 g of the salt lithium bis-trifluoromethanesulfonyl-imide (LiTFSI) is added and dissolved upon stirring. For this case the molar ratio ethyleneoxide/Li-ion is also 20. Again rather tough solid-like electrolyte films have been obtained, having a thickness of 360, respectively 420 microns. The sample preparation for the electrical conductivity testing is identical to example 1. The electrical conductivity is given in table 2.

TABLE 2

| Temperature | −10° C. | 23° C. | 40° C. | 80° C. |
|---|---|---|---|---|
| Electrical | 2*10⁻⁸ | 4*10⁻⁵ | 10⁻⁴ | 7*10⁻⁴ |
| conductivity in S/cm | | | | |

Conductivity levels for this example are much higher compared to example 2. For instance at 40° C. the conductivity equals 10⁻⁴ S/cm which is a factor 5 higher compared to example 1. For dry, non-gelled polymer based electrolytes 10-4 S/cm is considered a high conductivity value. For instance in ISBN 978-0-387-34444-7, Lithium-ion batteries, M. Yoshio, R. J. Brodd, A. Kozawa Editors, pages 4140415 it is stated that PEG-based copolymer systems show Li-ionic conductivity values in the range 10-10⁻⁴ S/cm and a value of 10⁻⁴ at 30° C. is considered really high. So, with respect to conductivity this sample is in the upperbound of what can be reached for polymer based electrolytes.

### EXAMPLE III

Polymer electrolyte films of TPE3 were prepared according to the procedure of the previous examples unless otherwise stated. 2,465 g of the dried polymer is dissolved in 15 ml of hexafluoroisopropanol (HFIP) in a stirred glass vessel. To this mixture, 0.691 g of the salt lithium bis-trifluoromethanesulfonyl-imide (LiTFSI) is added and dissolved upon stirring. For this case the molar ratio ethyleneoxide/Li-ion is 20. The sample preparation for the electrical conductivity testing is the same as to the previous examples, however no gold sputtering was applied. The films had a thickness of about 500 microns. The electrical conductivity is given in the table 3 at several temperatures.

TABLE 3

| Temperature | −10° C. | 23° C. | 40° C. | 80° C. |
|---|---|---|---|---|
| Electrical | 4*10⁻⁸ | 2*10⁻⁵ | 4*10⁻⁵ | 2*10⁻⁴ |
| conductivity in S/cm | | | | |

### Comparative Experiment A

Polymer electrolyte films of the PEG-DME were prepared according to the procedure of the previous examples unless otherwise stated. 3 g of the dried polymer is dissolved in 20 ml of hexafluoroisopropanol (HFIP) in a stirred glass vessel. To this mixture 0,473 g of the salt lithium bis-trifluoromethanesulfonyl-imide (LiTFSI) is added and dissolved upon stirring. Also for this case the molar ratio ethyleneoxide/Li-ion is 20. The sample preparation for the electrical conductivity testing is the same as to the previous examples, however no gold sputtering was applied. The films had a thickness of about 500 microns. The electrical conductivity is given in the table 4 at several temperatures.

TABLE 4

| Temperature | −10° C. | 23° C. | 40° C. | 80° C. |
|---|---|---|---|---|
| Electrical | 7*10⁻⁹ | 2.3*10⁻⁶ | 4*10⁻⁵ | 8*10⁻⁴ |
| conductivity in S/cm | | | | |

Surprisingly it is shown, that despite the lower PEG content in the electrolyte of the examples the conductivity is higher at the desired operating temperatures of between −10 and 40° C. This reflects the normal operating temperatures of rechargeable batteries.

### EXAMPLE IV

Polymer electrolyte films of TPE2 were prepared by melt processing in the following manner. TPE2 was dried for 24 hrs at 110 C in an oven system under dry nitrogen flush. 2.19 g of the dried polymer and 0.500 g of the salt lithium bis-trifluoromethanesulfonyl-imide (LiTFSI) were heated to 250 deg on a teflon film under inert, water-free conditions in a glovebox. For this case the molar ratio ethyleneoxide/Li-ion is 20. The TPE and salt were vigorously mixed at 250 deg by hand using a teflon spatula to assure full and homogeneous mixing. Subsequently, a second teflon foil was applied and slightly pressed by hand to form a homogeneous layer. After cooling back to room temperature, the polymer electrolyte film is cut into pieces and applied into a custom made stainless steel pressure cell allowing simultaneous preparation of samples with well-defined dimensions and electrochemical measurement. Sample of 2 cm² and 200 microns thickness were prepared applying temperature of 200 deg and 1.5 tons of pressure. DC electrical conductivity measurements were conducted in this pressure cell as described in example I. The electrical conductivity is given in the table 5 at several temperatures.

TABLE 5

| Temperature | 25° C. | 30° C. | 40° C. | 60° C. |
|---|---|---|---|---|
| Electrical | 4.3*10⁻⁵ | 7.5*10⁻⁵ | 1.5*10⁻⁴ | 3.6*10⁻⁴ |
| conductivity in S/cm | | | | |

By comparing the results in table 2 and 5 it is shown that by melt processing comparable electrical conductivity is obtained. This makes it possible to produce the battery by a melt extrusion process.

1. Solid polymer electrolyte material containing
a) a thermoplastic elastomer containing polyester, polyamide or diamide hard blocks and ionically conductive soft blocks and
b) a metal salt,
wherein the solid polymer electrolyte material has a total plasticizer content of less than 15 wt. %.

2. Solid polymer electrolyte material according to claim 1, wherein the ionically conductive soft blocks comprise polyethylene oxide (PEO).

3. Solid polymer electrolyte material according to claim 1, wherein the ionically conductive softblocks exist for at least 80 wt. % from PEO.

4. Solid polymer electrolyte material according to claim 1, wherein the ionically conductive softblocks exist for at least 90 wt. % from PEO.

5. Solid polymer electrolyte material according to claim 1, wherein the content of the ionically conductive soft block in the thermoplastic elastomer is at least 50 wt. %.

6. Solid polymer electrolyte material according to claim 1, wherein the hard blocks comprise a polyester.

7. Solid polymer electrolyte material according to claim 6, wherein the hard blocks comprise a polybutylene terephthalate.

8. Solid polymer electrolyte material according to claim 1, wherein the solid polymer electrolyte material has a total plasticizer content of less than 10 wt. %.

9. Solid polymer electrolyte material according to claim 1, wherein the solid polymer electrolyte material has a total plasticizer content of less than 5 wt. %.

10. Solid polymer electrolyte material according to claim 1, wherein the solid polymer electrolyte contains no plasticizer.

11. Solid polymer electrolyte material containing according to claim 1, wherein the metal salt comprises a cation of group Ia and IIa of the table of elements.

12. Solid polymer electrolyte material containing according to claim 11, wherein the cations for the salts include Li⁺ for a lithium battery, and Na⁺ for a sodium battery and Al³⁺ for Al batteries.

13. Solid polymer electrolyte material according to claim 1, wherein the salt comprises an anion of the group ClO₄⁻, SCN⁻, BF₄⁻, As F₆⁻, CF₃SO₃⁻, Br⁻, I⁻, PF₆⁻, (CF₃SO)₂N⁻, (CF₃SO)₃ C⁻, CF₃CO₂⁻, (FO₂S)₂N⁻.

14. Spacer between adjacent electrodes of a battery, especially of a rechargeable battery, the spacer comprising the solid polymer electrolyte material according to claim 1.

15. Electrode, especially an electrode for a rechargeable battery, comprising the solid polymer electrolyte material according to claim 1.

16. Battery, especially a rechargeable battery, comprising an adhesive film of the polymer electrolyte material of claim 1 between the anode and/or the cathode at one hand and the spacer adjacent to the at least one anode and/or at least one cathode at the other hand.

17. Battery according to claim 16, wherein the spacer is a ceramic spacer.
